(19) United States
(12) Patent Application Publication
(10) Pub. No.: US 2026/0189898 A1
(43) Pub. Date: Jul. 2, 2026

(54) MANAGING SUBSCRIBER IDENTITY MODULE REFRESH DURING USER ACTIVITY

(71) Applicant: GOOGLE LLC, Mountain View, CA (US)

(72) Inventor: Edison Chen, Taipei (TW)

(21) Appl. No.: 19/130,771

(22) PCT Filed: Dec. 14, 2022
(86) PCT No.: PCT/US2022/052785

§ 371 Date: May 16, 2025

(51) Int. Cl. H04W 8/18

(52) U.S. Cl. CPC H04W 8/18

(57) ABSTRACT

A user equipment (UE) device in a mobile cellular network implements one or more techniques to manage subscriber identity module (SIM) refresh events. For example, the UE device receives a refresh command from a SIM. The UE device identifies whether there is current user activity at the UE device. Responsive to the current user activity at the UE device, the UE device queues the refresh command until one or more predetermined conditions are satisfied.

### BACKGROUND

Wireless communication has become a leading medium for accessing and receiving data. In many cases, a user equipment (UE) device communicates through cellular data networks that operate within an administratively licensed band, such that only licensed cellular network operators are permitted to establish data networks (each a “primary cellular data network”) within the licensed band. The licensed operators are allocated respective spectra within the licensed band which prevents unlicensed operators from utilizing the licensed band.

To connect with a primary cellular data network, the UE device utilizes a subscription profile that is administered by an associated mobile network operator. The subscription profile generally includes an international mobile subscriber identity (IMSI) number and its related key. The subscription profile is typically stored on the subscriber identity module (SIM) of the UE device and provides the UE device with network access information for access to the associated primary cellular data network. A subscription profile may allow the user UE to connect to multiple associated primary cellular data network nodes such that the UE device can communicate with the associated primary cellular data network within a wide geographic area.

### SUMMARY OF EMBODIMENTS

In accordance with some embodiments, a method at a cellular user equipment (UE) device manages subscriber identity module (SIM) refresh events. The method includes the UE device receiving a refresh command from a SIM. The UE device identifies whether there is current user activity at the UE device. Responsive to current user activity at the UE device, the UE device queues the refresh command until one or more predetermined conditions are satisfied.

In various embodiments, this method further can include one or more of the following aspects: responsive to the current user activity at the UE device, initiating a timer; responsive to initiating the timer, determining whether at least one predetermined condition of the one or more predetermined conditions has been satisfied, and responsive to the at least one predetermined condition having been satisfied, processing the refresh command; wherein the at least one predetermined condition is the current user activity completing prior to the timer expiring; responsive to initiating the timer, determining whether at least one predetermined condition of the one or more predetermined conditions has been satisfied, and responsive to the at least one predetermined condition having been satisfied, rejecting the refresh command; wherein the at least one predetermined condition is the timer expiring prior to the current user activity completing; responsive to no current user activity at the UE device, processing the refresh command; responsive to the current user activity at the UE device, determining whether a refresh enforcement policy is enabled for the current user activity, wherein queuing the refresh command is further in response to a refresh enforcement policy not being enabled for the current user activity; responsive to the current user activity at the UE device, determining whether a refresh enforcement policy is enabled for the current user activity, and responsive to a refresh enforcement policy being enabled for the current user activity, processing the refresh command.

In accordance with some embodiments, a method at a cellular user equipment (UE) device manages subscriber identity module (SIM) refresh events. The method includes the UE device receiving a refresh command from a SIM. The UE device identifies whether there is current user activity at the UE device. Responsive to the current user activity at the UE device, the UE device queues the refresh command and initiating a timer. Responsive to no current user activity at the UE device, the UE device processes the refresh command.

In various embodiments, this method further can include one or more of the following aspects: responsive to the current user activity at the UE device, determining if a refresh enforcement policy is enabled for the current user activity, wherein queuing the refresh command and initiating the timer is responsive to the refresh enforcement policy not being enabled for the current user activity; responsive to the current user activity at the UE device, determining if a refresh enforcement policy is enabled for the current user activity, and responsive to the refresh enforcement policy being enabled for the current user activity, processing the refresh command; responsive to the refresh enforcement policy not being enabled for the current user activity, determining if the current user activity has completed before the timer has expired, responsive to the current user activity having completed before the timer has expired, processing the refresh command, and responsive to the current user activity having not completed before the timer has expired, rejecting the refresh command.

In accordance with some embodiments, a user equipment device is configured to perform any of the methods described above and herein.

In accordance with some embodiments, a non-transitory computer-readable medium includes storing executable instructions configured to manipulate a processor of a user equipment device to implement the methods described above and herein.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example wireless communication system employing a user equipment (UE) device implementing one or more mechanisms for managing subscriber identity module (SIM) refresh events in accordance with some embodiments.

FIG. 2 is a block diagram illustrating example modes of a SIM refresh handling/managing mechanism employed by the UE device of FIG. 1 in accordance with some embodiments.

FIG. 3 is a diagram illustrating an example configuration of a UE device implementing one or more mechanisms for managing SIM refresh events in accordance with some embodiments.

FIG. 4 illustrates a diagram of an example operation of implementing SIM refresh event management at a UE device in accordance with some embodiments.

### DETAILED DESCRIPTION

A wireless communication device (also referred to herein as a user equipment (UE) device) typically includes a subscriber identity module (SIM), such as a physical SIM card, virtual SIM, or an embedded SIM (eSIM), that stores information relating to a subscriber identity associated with the UE device. For example, one type of a SIM is a universal integrated circuit card (UICC) that stores information, such as authentication information, authorization information, identification information, and the like, for accessing different network services. In many instances, a mobile network operator (MNO) periodically updates a SIM with new information and instructions so that the UE device can function properly on the wireless communication network and to ensure secure access to the network. When the SIM receives an update from the network, the SIM initiates an update procedure, which is also referred to herein as a SIM refresh procedure or a SIM refresh, to update information or instructions stored on the SIM. As part of the SIM refresh procedure, the SIM sends a refresh command or notification to the UE device so that the UE device can process the SIM update.

During a SIM refresh, the UE device typically cannot perform functions associated with user activity, such as processing a voice call or a short message service (SMS) message. Thus, if the UE device processes a SIM refresh while user activity is in progress at the UE device, the user activity will likely be dropped, resulting in, for example, performance issues and a poor user experience. Therefore, because a SIM refresh can interfere with various user activities at the UE device, the MNO generally stipulates that the UE device is to reject (i.e., not perform) a SIM refresh while user activity is in progress at the UE device. However, rejecting the SIM refresh during user activity is problematic because the SIM is typically not required to retry the refresh procedure, resulting in a failure of the UE device to update the information it maintains about the SIM.

To prevent these and other issues involving SIM refreshes, a UE device, using the techniques described herein, employs a SIM refresh handling mechanism to advantageously handle SIM refresh events during user activity at the UE device. For example, in at least some embodiments, when a UE device receives a refresh proactive command (also referred to herein as a SIM refresh command) from a SIM, the UE device identifies whether there is any user activity (or specified user activity), such as an active Emergency Call Center (ECC) call, an enabled active emergency callback mode, an active voice call, an ongoing SMS process, active menu navigation, or the like.

If there is no user activity, the UE device processes the SIM refresh command. If there is active user activity, the UE device further identifies if the user activity is associated with a refresh enforcement policy and handles the SIM refresh command accordingly. For example, in at least some embodiments, the MNO programs the SIM with a refresh enforcement policy that the MNO can enable or disable. If the UE device determines a refresh enforcement policy is enabled for the user activity, the UE device proceeds to process the SIM refresh command. If the UE device determines the user activity is not associated with a refresh enforcement policy or an associated refresh enforcement policy is disabled, the UE device queues (e.g., holds) the SIM refresh command. The UE device initiates a timer and waits for the user activity to complete. In at least some embodiments, the UE device determines if the user activity has completed by registering a callback with a user activity module for the completion status of the user activity, polling the user activity module at given intervals of time, a combination thereof, or the like. If the user activity completes prior to the timer expiring, the UE device processes the refresh command and resets the timer. However, if the user activity does not complete before the timer expires, the UE device rejects the SIM refresh command to prevent the user activity from being dropped and waits for a SIM retry. As such, the techniques described herein queue a received SIM refresh command while user activity is occurring at the UE device instead of immediately rejecting the command. By queuing the SIM refresh command, the UE device provides an opportunity for the user activity to complete before rejecting the SIM refresh, which helps the UE device from missing SIM updates. It should be understood that a SIM is an example used throughout this description for purposes of illustration, and the techniques described herein are not limited to a SIM but to any subscriber identity format that uses the same or similar refresh operation.

For ease of illustration, the following techniques are described in an example context in which one or more UE devices and radio access networks (RANs) implement one or more radio access technologies (RATs), including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, it should be understood that the present disclosure is not limited to networks employing a 5G NR RAT configuration, but rather the techniques described herein can be applied to any combination of different RATs employed at the UE devices and the RANs. It should also be understood that the present disclosure is not limited to any specific network configurations or architectures described herein for implementing SIM refresh handling at the UE device. Instead, techniques described herein can be applied to any configuration of RANs. Also, the present disclosure is not limited to the examples and context described herein, but rather the techniques described herein can be applied to any network environment where a UE device implements SIM refresh handling techniques.

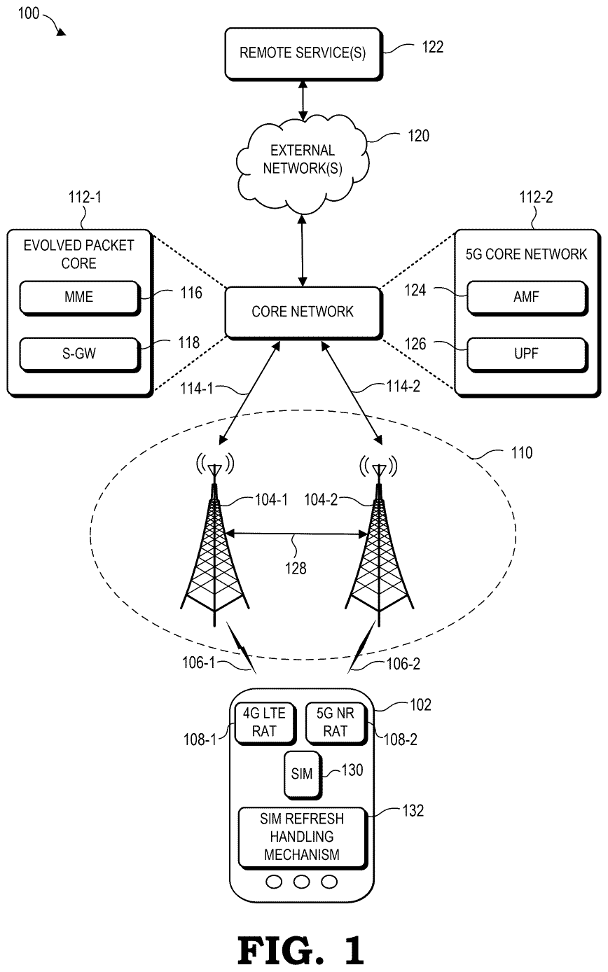

FIG. 1 illustrates a mobile cellular network (system) 100 in accordance with at least some embodiments. As shown, the mobile cellular network 100 includes a user equipment (UE) device 102 that is configured to implement the techniques described herein for handling/managing SIM refresh events in accordance with one or more embodiments. The UE device 102 communicates with one or more base stations (BSs) 104 (BSs 104-1 and 104-2) through one or more wireless communication links 106 (wireless links 106-1 and 106-2). The UE device 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE device 102 employs a single radio access technology (RAT) 108. In other embodiments, the UE device 102 is a multi-mode UE device that employs multiple RATs 108. Examples of multiple RATs include a 3GPP Long-Term Evolution (3GPP LTE) RAT 108-1 and a 3GPP Fifth Generation New Radio (5G NR) RAT 108-2.

In at least some embodiments, the BSs 104 are implemented in a macrocell, microcell, small cell, picocell, and the like, or any combination thereof. Examples of BSs 104 include an Evolved Universal Terrestrial Radio Access Network Node B (E-UTRAN Node B), evolved node B (eNodeB or eNB), Next Generation (NG or NGEN) Node B (gNode B or gNB), and so on. The BSs 104 communicate with the UE device 102 via the wireless links 106, which are implemented using any suitable type of wireless link. The wireless links 106, in at least some embodiments, include a downlink of data and control information communicated from the BSs 104 to the UE device 102, an uplink of data and control information communicated from the UE device 102 to the BSs 104, or both. The wireless links 106 (or bearers), in at least some embodiments, are implemented using any suitable communication protocol or standard, or combination of communication protocols or standards, such as 3GPP 4G LTE, 5G NR, and so on. In at least some embodiments, multiple wireless links 106 are aggregated in a carrier aggregation to provide a higher data rate for the UE device 102. Also, multiple wireless links 106 from multiple BSs 104 are configured, in at least some embodiments, for coordinated multipoint (COMP) communication with the UE device 102, as well as dual connectivity, such as single-RAT LTE-LTE or NR-NR dual connectivity, or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC). In at least some embodiments, a BS 104 also includes an inter-base station interface 128, such as an Xn and/or X2 interface configured to exchange user-plane and control-plane data between another BS 104.

The BSs 104 collectively form a Radio Access Network 110, such as an E-UTRAN or 5G NR RAN. The BSs 104 are connected to a core network 112 via control-plane and user-plane interfaces through one or more links 114 (links 114-1 and 114-2). Depending on the configuration of the mobile cellular network 100, the core network 112 is either an evolved packet core (EPC) network 112-1 or a 5G core network (5GC) 112-2. For example, in an E-UTRAN configuration or a 5G non-standalone (NSA) EN-DC configuration, the core network 112 is an EPC network 112-1 that includes, for example, a mobility management entity (MME) 116 and a serving gateway (S-GW) 118. The MME 116 provides control-plane functions, such as registration and authentication of multiple UE devices 102, authorization, mobility management, and so on. The S-GW 118 relays user-plane data between UE devices 102 and external networks 120 (e.g., the Internet) and one or more remote services 122. In a 5G standalone (SA) configuration or an NSA NE-DC or NGEN-DC configuration, the core network 112 is a 5GC network 112-2. The 5GC 112-2 includes, for example, an access and mobility management function (AMF) 124 and a user plane function (UPF) 126. The AMF 124 provides control-plane functions such as registration and authentication of multiple UE devices 102, authorization, mobility management, and so on. The UPF 126 relays user-plane data between UE devices 102 and external networks 120 (e.g., the Internet) and one or more remote services 122.

In one or more embodiments, the UE device 102 includes a subscriber identity module (SIM) 130. As used herein, the terms subscriber identity module, SIM, or identity module, refer to any circuit (integrated or discrete), chip, card or smart card, and the like that includes information about the user of the UE device 102 used for authenticating the user to the network 100 providing access to subscribed services. In at least some embodiments, the SIM 130 stores networking information and subscriber information for the UE device 102. The SIM 130 uniquely identifies the UE device 102 on the mobile cellular network 100 and validates the UE device's right to use the mobile cellular network 100. During operation of the UE device 102, the core network 112 sends an update to the UE device 102 for updating the SIM 130. For example, the core network 112 may want to update the phone number associated with the SIM 130, update the IMSI, or perform another update. When the SIM 130 receives the update from the core network 112, the SIM 130 sends a SIM refresh command (e.g., a refresh proactive command) to a component of the UE device 102, such as a processor (e.g., an application processor). The SIM refresh command notifies the UE component that the content or structure of files (e.g., elementary files) on the SIM 130 have changed, and instructs the UE component to refresh information that it maintains about the SIM 130.

In many instances, a UE device receives the SIM refresh command when user activity is occurring at the UE device. Examples of user activity include active emergency call center (ECC) call, an enabled active emergency callback mode, an active voice call, an ongoing SMS process, active menu navigation, or the like. In a typical configuration, a UE device rejects the SIM refresh command when user activity is occurring at the UE device or, if the user activity is associated with an enforcement policy, the UE device processes the SIM refresh command. However, in a scenario where the UE device rejects the SIM refresh command, the SIM is not required to reissue the SIM refresh command. In these instances, the UE device typically does not process the SIM refresh command and update its corresponding SIM information. In a scenario where the UE device processes the SIM refresh command, the UE device will often drop the current user activity. For example, the UE device, drops the active voice call or SMS messaging process, which results in poor performance and user experience.

Accordingly, in at least some embodiments, the UE device 102 employs one or more SIM refresh handling mechanisms 132 to advantageously manage SIM refresh events when user activity is occurring at the UE device 102. As described in greater detail below, the SIM refresh handling mechanism(s) 132 includes one or more modes to facilitate the SIM refresh handling techniques described herein. For example, when user activity is occurring and the UE device 102 receives a SIM refresh command, the UE device queues the SIM refresh command instead of immediately rejecting the command. By queuing the SIM refresh command, the UE device 102 provides an opportunity for the user activity to complete before rejecting the SIM refresh command, which helps avoid failure of the UE device to update its corresponding SIM information.

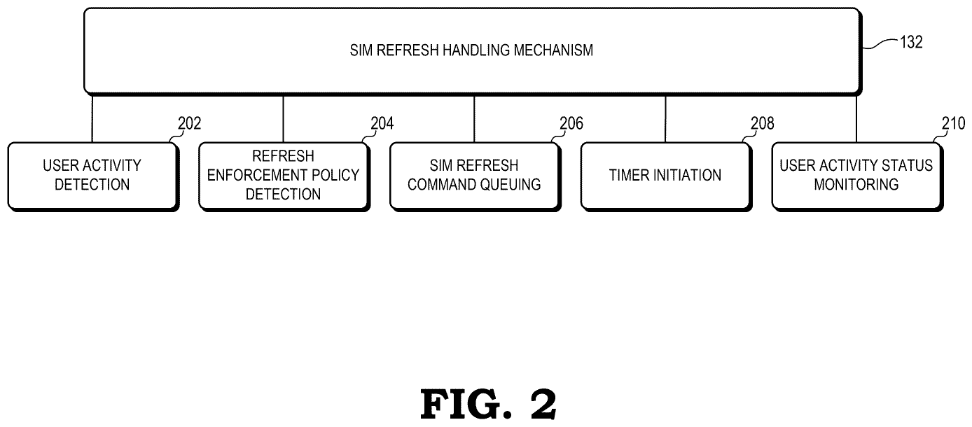

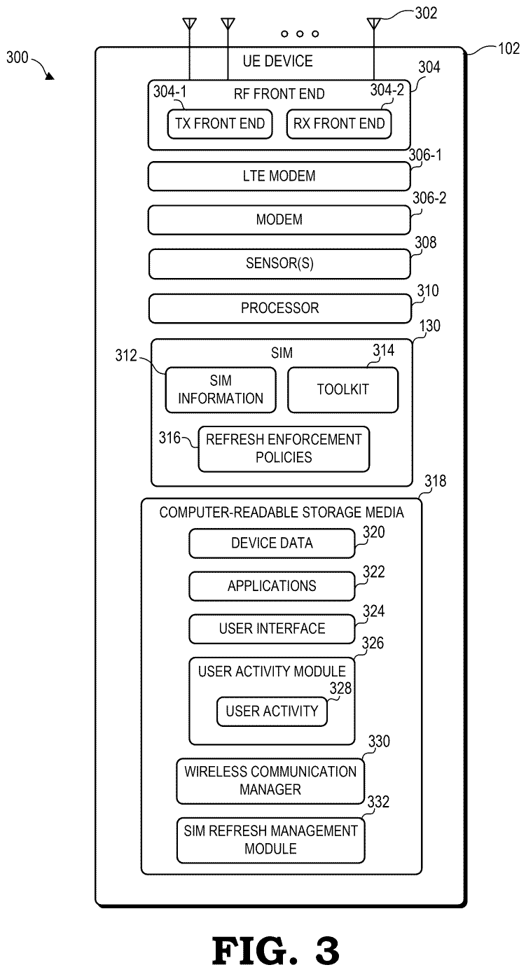

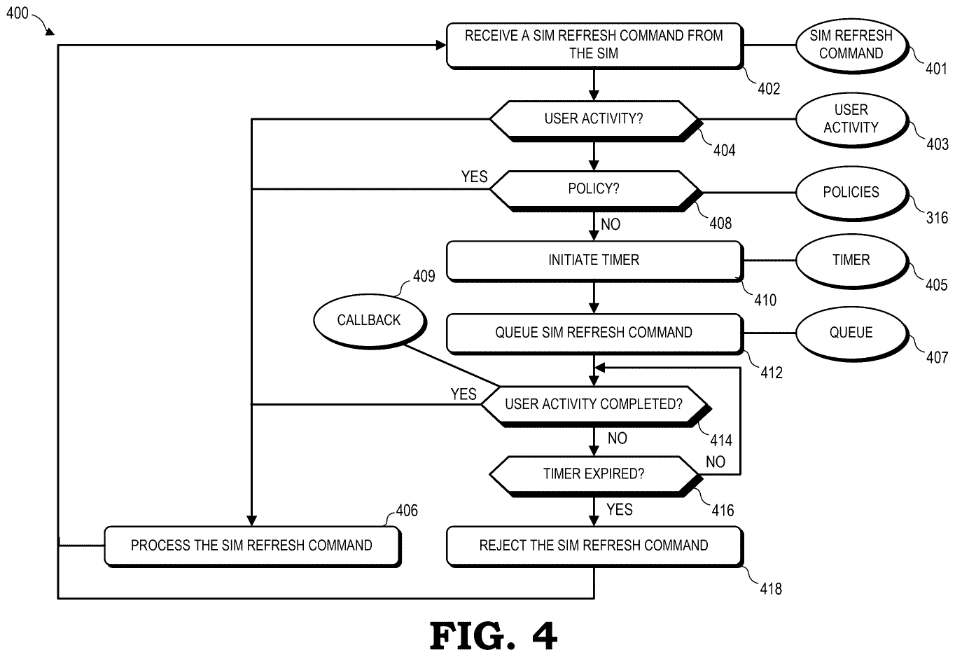

FIG. 2 illustrates various example modes employed singularly or in various combinations by the UE device 102 as part of the SIM refresh handling mechanism 132 in accordance with some embodiments. Each of these modes is discussed in greater detail below with respect to FIG. 3 and FIG. 4. One such mode includes a first SIM refresh handling mode 202. In this mode, the SIM refresh handling mechanism 132 monitors for user activity at the UE device 102. In response to determining that no user activity (or specified user activity) is occurring at the UE device 102, the SIM refresh handling mechanism 132 instructs one or more components of the UE device 102 to process the SIM refresh command. However, if user activity is occurring at the UE device 102, a second SIM refresh handling mode 204 determines if the user activity is associated with a refresh enforcement policy. A refresh enforcement policy forces the refresh command to be processed by the UE device 102 even though the user activity is occurring. If the user activity is associated with a refresh enforcement policy, the SIM refresh handling mechanism 132 instructs one or more components of the UE device 102 to process the SIM refresh command. If the user activity is not associated with a refresh enforcement policy, a third SIM refresh handling mode 206 queues the SIM refresh command. A fourth SIM refresh handling mode 208 then initiates a timer and a fifth SIM refresh handling mode 210 monitors the status of the user activity. For example, during execution of the timer, a determination is made whether the user activity has completed. If the user activity completes prior to the timer expiring, the SIM refresh handling mechanism 132 instructs one or more components of the UE device 102 to process the SIM refresh command and resets the timer. However, if the user activity does not complete before the timer expires, the SIM refresh handling mechanism 132 (or another component) rejects the refresh command to prevent the user activity from being dropped and waits for a SIM refresh retry by the SIM 130.

FIG. 3 illustrates an example device diagram 300 of a UE device 102. In at least some embodiments, the device diagram 300 describes a UE device that implements the SIM refresh handling techniques described herein. The UE device 102 may include additional functions and interfaces that are omitted from FIG. 3 for the sake of clarity. The UE device 102, in at least some embodiments, includes antennas 302, a radio frequency (RF) front end 304, and one or more RF transceivers 306 (e.g., a 3GPP 4G LTE transceiver 306-1 and a 5G NR transceiver 306-2) for communicating with one or more base stations 104 in a RAN 110, such as a 5G RAN, an E-UTRAN, a combination thereof, and so on. The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the one or more transceivers 306, such as the LTE transceiver 306-1 and the 5G NR transceiver 306-2, to the antennas 302 to facilitate various types of wireless communication.

In at least some embodiments, the antennas 302 of the UE device 102 include an array of multiple antennas configured similar to or different from each other. The antennas 302 and the RF front end 304, in at least some embodiments, are tuned to or are tunable to one or more frequency bands, such as those defined by the 3GPP LTE, 3GPP 5G NR, IEEE wireless local area network (WLAN), IEEE wireless metropolitan area network (WMAN), or other communication standards. In at least some embodiments, the antennas 302, the RF front end 304, the LTE transceiver 306-1, and the 5G NR transceiver 306-2 are configured to support beamforming (e.g., analog, digital, or hybrid) or in-phase and quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 GHz bands, above 6 GHz bands, or a combination of these bands defined by the 3GPP LTE, 3GPP 5G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE device 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE device 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 308 implemented to detect various properties such as one or more of temperature, supplied power, power usage, battery state, or the like. Examples of sensors include a thermal sensor, a battery sensor, a power usage sensor, and so on. The UE device 102 also includes at least one processor 310. The processor 310, in at least some embodiments, is a single-core processor or a multiple-core processor composed of a variety of materials, such as silicon, polysilicon, high-K dielectric, copper, and so on. In at least some embodiments, the processor 310 is implemented at least partially in hardware including, for example, components of an integrated circuit or a system-on-a-chip (SoC), a digital-signal-processor (DSP), an application-specific integrated circuit (ASIC), a field-programmable gate array (FPGA), a complex programmable logic device (CPLD), other implementations in silicon or other hardware, or a combination thereof.

Examples of the processor(s) 310 include a communication processor, an application processor, microprocessors, DSPs, controllers, and so on. A communication processor, in at least some embodiments, is implemented as a modem baseband processor, software-defined radio module, configurable modem (e.g., multi-mode, multi-band modem), wireless data interface, wireless modem, or so on. In at least some embodiments, a communication processor supports one or more of data access, messaging, or data-based services of a wireless network, as well as various audio-based communication (e.g., voice calls). An application processor, in at least some embodiments, provides computing resources to applications executing on the UE device 102. For example, an application provides a self-contained operating environment that delivers system capabilities (e.g., graphics processing, memory management, and multimedia processing) to support applications executing on the UE device 102.

The UE device 102 further includes one or more SIMs 130. The SIM 130, in at least some embodiments, is a physical SIM or an embedded SIM (eSIM). One example of the SIM 130 includes a universal integrated circuit card (UICC) that can store one or more eSIMs for accessing different MNOs. The SIM 130 uniquely identifies the UE device 102 on the mobile cellular network 100 and validates the UE device's right to use the mobile cellular network 100. In at least some embodiments, the SIM 130 comprises one or more of SIM information 312, an application toolkit 314, refresh enforcement policies 316, and the like. It should be understood that the SIM 130 can include additional components not shown in FIG. 3. The SIM information 312, in at least some embodiments, comprises information such as an IMSI number and its related key, authentication information, authorization information, identification information, and the like, for accessing different network services. The application toolkit 314, in at least some embodiments, is a set of commands or applications that are programmed into the SIM 130 that define how the SIM 130 is to interact with an environment (e.g., the mobile cellular network 100) outside of the UE device 102. The refresh enforcement policies 316, in at least some embodiments, are policies set and enabled/disabled by the MNO that indicate to the UE device 102 if a SIM refresh command is to be processed even if a specified user activity is occurring at the UE device 102. Stated differently, an enabled refresh enforcement policy 316 forces the UE device 102 to process a SIM refresh command even if the SIM refresh command interferes with a specified user activity. Examples of user activity include an active ECC call, an enabled active emergency callback mode, an active voice call, an ongoing SMS process, active menu navigation, and the like. A refresh enforcement policy 316 can be programmed or enabled/disabled for each of these and other user activities.

The UE device 102 further includes a non-transitory computer-readable storage media 318 (CRM 318). The computer-readable storage media described herein excludes propagating signals. The CRM 318, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 320 of the UE device 102. In at least some embodiments, the device data 320 includes user data, multimedia data, beamforming codebooks, applications 322, a user interface(s) 324, one or more user activity modules 326, an operating system of the UE device 102, and so on, which are executable by the processor(s) 310 to enable user-plane communication, control-plane signaling, and user interaction with the UE device 102. Alternatively, or additionally, the operating system of the UE device 102 is maintained as firmware or an application on the CRM 318 and executed by the processor(s) 310. In at least some embodiments, the user interface 324 includes a graphical user interface (GUI) that receives the input information via a touch input. In other instances, the user interface 324 includes an intelligent assistant that receives the input information via an audible input or speech. The user activity module(s) 326 monitors/handles user activity occurring at the UE device 102 and stores an indication or information 328 associated with the occurring user activity. For example, the user activity module 326 stores an indication that one or more of an active ECC call, an enabled active emergency callback mode, an active voice call, an ongoing SMS process, active menu navigation, or the like is currently occurring at the UE device 102. Alternatively, or additionally, the user activity module 326 is implemented in the processor 310, the SIM 130, or both. In at least some implementations, the user activity module 326 is comprised of multiple user activity modules that each monitor/handle a specified type of user activity. For example, the user activity module 326 comprises an ECC activity module, a voice call activity module, and an SMS activity module, and the like.

In at least some embodiments, the CRM 318 also includes either or both of a communication manager 330 and a SIM refresh management module 332. Alternatively, or additionally, either or both of the communication manager 330 and the SIM refresh management module 332, in at least some embodiments, are implemented in whole or part as hardware logic or circuitry integrated with or separate from other components of the UE device 102. In at least some embodiments, the communication manager 330 configures the RF front end 304, the LTE transceiver (modem) 306-1, the 5G NR transceiver (modem) 306-2, or a combination thereof, to perform one or more wireless communication operations. The SIM refresh management module 332, in at least some embodiments, implements the SIM refresh handling mechanism(s) 132 for advantageously handling SIM refresh events when user activity is occurring at the UE device 102, as described in greater detail below with respect to FIG. 4.

FIG. 4 illustrates, in flow chart form, one example method 400 of the SIM refresh management module 332 (or another component) of the UE device 102 managing SIM refresh events. For purposes of description, the method 400 is described with respect to an example implementation at the UE device 102 of FIG. 3, but it will be appreciated that, in other implementations, the method 400 is implemented at UE devices 102 having different configurations. At block 402, the SIM refresh management module 332 receives (or detects) a SIM refresh command 401 from the SIM 130. In at least some embodiments, the SIM 130 sends the SIM refresh command 401 to the UE device 102. The SIM refresh command 401 notifies the UE device 102 that an update has occurred at the SIM 130 so that the UE device can re-read the SIM 130 to update its corresponding SIM information.

At block 404, the SIM refresh management module 332 determines if there is any user activity 403 (or specified user activity) active (e.g., occurring) at the UE device 102. For example, the SIM refresh management module 332 determines if there is an active ECC call, an enabled active emergency callback mode, an active voice call, an ongoing SMS process, active menu navigation, or the like occurring at the UE device 102. In at least some embodiments, the SIM refresh management module 332 communicates with the user activity module 326 of the UE device 102, which maintains user activity information 328 identifying any current user activity 403 occurring at the UE device 102. For example, the SIM refresh management module 332 (or another component of the UE device 102) sends a voting request to the one or more user activity modules 326. If the user activity module(s) 326 determines that user activity 403 is occurring at the UE device 102, the user activity module(s) 326 returns a vote response to the SIM refresh management module 332 indicating that the user activity 402 is occurring. The SIM refresh management module 332 collects all vote responds to determine if there is any current user activity 403 at the UE device 102. If the user activity 403 is inactive (e.g., not currently occurring) at the UE device 102, the method 400 flows to block 406, and the SIM refresh management module 332 processes the SIM refresh command 401 or instructs one or more components of the UE device 102 to process the SIM refresh command 401.

If user activity 403 is active at the UE device 102, the method 400 flows to block 408, and the SIM refresh management module 332 determines if a refresh enforcement policy 316 is associated with the active user activity 403. In at least some embodiments, the SIM 130 (or another component) of the UE device 102 maintains refresh enforcement policies 316 for specified user activity 403. If a refresh enforcement policy 316 is associated with and enabled for the user activity 403 that is active at the UE device 102, the method 400 flows to block 406, and the SIM refresh management module 332 processes the SIM refresh command 401 or instructs one or more components of the UE device 102 to process the SIM refresh command 401.

If a refresh enforcement policy 316 is not associated with or is disabled for the occurring user activity 403, the method 400 flows to block 410, and the SIM refresh management module 332 initiates a timer 405. At block 412, the SIM refresh management module 332 queues the SIM refresh command 401. For example, the SIM refresh management module 332 places the SIM refresh command 401 in a queue 407, such as a buffer or other temporary holding structure. In at least some embodiments, the SIM refresh management module 332 queues the SIM refresh command 401 until one or more conditions are satisfied, such as the user activity 403 completing prior to the timer 405, the timer 405 expiring, or the like.

At block 414, the SIM refresh management module 332 determines if the user activity 403 has completed. In at least some embodiments, the SIM refresh management module 332 determines if the user activity 403 has completed by registering a callback 409 with the user activity module 326 for the completion status of the user activity 403. Alternatively, or additionally, the SIM refresh management module 332 pols the user activity module 326 at given intervals of time to determine the completion status of the user activity 403. However, other techniques for determining or obtaining the completion status of the user activity 403 are applicable as well. If the user activity 403 has completed prior to the timer 405 expiring, the method 400 flows to block 406, and the SIM refresh management module 332 processes the SIM refresh command 401 or instructs one or more components of the UE device 102 to process the SIM refresh command 401. If the user activity 403 has not completed, the SIM refresh management module 332 determines if the timer 405 has expired at block 416. If the timer 405 has not expired, the SIM refresh management module 332 continues to monitor the completion status of the user activity 403. If the timer 405 has expired, the method flows to block 418, and the SIM refresh management module 332 rejects the SIM refresh command 401. For example, the SIM refresh management module 332 sends a TERMINAL RESPONSE (or other message/response type) to the SIM 130 indicating that the UE device 102 is unable to process the SIM refresh command 401. In at least some embodiments, the SIM refresh management module 332 then waits for the SIM 130 to reissue the SIM refresh command 401.

As such, the techniques described herein queue a received SIM refresh command 401 while user activity 403 is occurring at the UE device 102 instead of immediately rejecting the command 401. By queuing the SIM refresh command 401, the UE device 102 provides an opportunity for the user activity 403 to complete before rejecting the SIM refresh command 401, which helps avoid failure of the UE device 102 to update its corresponding SIM information.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method at a cellular user equipment (UE) device for managing subscriber identity module (SIM) refresh events, the method comprising:
receiving a refresh command from a SIM;
identifying whether there is current user activity at the UE device; and
responsive to the current user activity at the UE device, queuing the refresh command until one or more predetermined conditions are satisfied.

2. The method of claim 1, further comprising:
responsive to the current user activity at the UE device, initiating a timer.

3. The method of claim 2, further comprising:
responsive to initiating the timer, determining whether at least one predetermined condition of the one or more predetermined conditions has been satisfied; and
responsive to the at least one predetermined condition having been satisfied, processing the refresh command.

4. The method of claim 3, wherein the at least one predetermined condition is the current user activity completing prior to the timer expiring.

5. The method of claim 2, further comprising:
responsive to initiating the timer, determining whether at least one predetermined condition of the one or more predetermined conditions has been satisfied; and
responsive to the at least one predetermined condition having been satisfied, rejecting the refresh command.

6. The method of claim 5, wherein the at least one predetermined condition is the timer expiring prior to the current user activity completing.

7. The method of claim 1, further comprising:
responsive to no current user activity at the UE device, processing the refresh command.

8. The method of claim 1, further comprising:
responsive to the current user activity at the UE device, determining whether a refresh enforcement policy is enabled for the current user activity, wherein queuing the refresh command is further in response to a refresh enforcement policy not being enabled for the current user activity.

9. The method of claim 1, further comprising:
responsive to the current user activity at the UE device, determining whether a refresh enforcement policy is enabled for the current user activity; and
responsive to a refresh enforcement policy being enabled for the current user activity, processing the refresh command.

10. A method at a cellular user equipment (UE) device for managing subscriber identity module (SIM) refresh events, the method comprising:
receiving a refresh command from a SIM;
identifying whether there is current user activity at the UE device;
responsive to the current user activity at the UE device, queuing the refresh command and initiating a timer; and
responsive to no current user activity at the UE device, processing the refresh command.

11. The method of claim 10, further comprising:
responsive to the current user activity at the UE device, determining if a refresh enforcement policy is enabled for the current user activity,
wherein queuing the refresh command and initiating the timer is responsive to the refresh enforcement policy not being enabled for the current user activity.

12. The method of claim 10, further comprising:
responsive to the current user activity at the UE device, determining if a refresh enforcement policy is enabled for the current user activity; and
responsive to the refresh enforcement policy being enabled for the current user activity, processing the refresh command.

13. The method of claim 11, further comprising:
responsive to the refresh enforcement policy not being enabled for the current user activity, determining if the current user activity has completed before the timer has expired;
responsive to the current user activity having completed before the timer has expired, processing the refresh command; and
responsive to the current user activity having not completed before the timer has expired, rejecting the refresh command.

14. A user equipment device configured to implement the method of claim 10.

15. A non-transitory computer-readable medium storing executable instructions configured to manipulate a processor of a user equipment device to implement the method of claim 1.

16. A user equipment (UE) device comprising:
a radio frequency (RF) front end;
at least one modem coupled to the RF front end;
at least one processor; and
memory storing a set of executable instructions, the set of executable instructions configured to manipulate one or both of the at least one modem or the at least one processor to:
receive a refresh command from a subscriber identity module (SIM);
identify whether there is current user activity at the UE device; and
responsive to the current user activity at the UE device, queuing the refresh command until one or more predetermined conditions are satisfied.

17. The UE device of claim 16, wherein the executable instructions further are to manipulate one or both of the at least one modem or the at least one processor to:
responsive to the current user activity at the UE device, initiate a timer; and
responsive to no current user activity at the UE device, processing the refresh command.

18. The UE device of claim 17, wherein the executable instructions further are to manipulate one or both of the at least one modem or the at least one processor to:
responsive to the current user activity at the UE device, determine if a refresh enforcement policy is enabled for the current user activity,
wherein queuing the refresh command and initiating the timer is responsive to the refresh enforcement policy not being enabled for the current user activity.

19. The UE device of claim 17, wherein the executable instructions further are to manipulate one or both of the at least one modem or the at least one processor to:
responsive to the current user activity at the UE device, determine if a refresh enforcement policy is enabled for the current user activity; and
responsive to the refresh enforcement policy being enabled for the current user activity, process the refresh command.

20. The UE device of claim 19, wherein the executable instructions further are to manipulate one or both of the at least one modem or the at least one processor to:
responsive to the refresh enforcement policy not being enabled for the current user activity, determine if the current user activity has completed before the timer has expired;
responsive to the current user activity having completed before the timer has expired, process the refresh command; and
responsive to the current user activity having not completed before the timer has expired, reject the refresh command.
